(19) United States
(12) Patent Application Publication
(10) Pub. No.: US 2003/0108761 A1
(43) Pub. Date: Jun. 12, 2003

(54) Anti-bacterial paper products

(76) Inventor: Tammy Eddlemon, Weatherford, TX (US)

Correspondence Address: Kenneth C. Hill, HILL & HUNN, LLP., Suite 1440, 201 Main Street, Fort Worth, TX, 76102-3105, US

(21) Appl. No.: 10/242,400

(22) Filed: Sep. 12, 2002

Related U.S. Application Data
(60) Provisional application No. 60/322,326, filed on Sep. 12, 2001.

(51) Int. Cl. B32B 27/08

(52) U.S. Cl. 428/537.5; 428/503

(57) ABSTRACT

Paper products are provided with antibiotic and antimicrobial materials at the time the paper products are made. The antimicrobial materials can be incorporated into the product either during original manufacture, or by application after the paper is formed. Incorporation of these materials into various paper products enhances the ability of these products to minimize surface contamination by unwanted bacteria.

### CLAIM OF PRIORITY

This application claims the benefit of U.S. Provisional Patent Application Serial No. 60/322,326, filed Sep. 12, 2001, entitled “Anti-Bacterial Paper Products.” This provisional application is incorporated herein as if fully set forth.

### BACKGROUND OF THE INVENTION

1. Field of the Invention

The present invention relates generally to paper products, and more specifically to the inclusion of antimicrobial materials and to paper products.

2. Description of the Prior Art

Paper products are used in an extremely wide variety of applications. Paper in various forms is used in products packing, including food packaging, food handling, and numerous uses related to cleaning and personal hygiene. Examples of some products include paper cups and plates, paper towels, and facial tissues.

In many situations, paper products can be exposed to airborne bacteria prior to their use. This contributes to the spread of various types of disease and infection through passing of bacteria transferred on the surface of paper products.

Although numerous products are available for antibacterial and antimicrobial purposes, such products have drawbacks in actual use. Typically, various types of wipes and washes are used for cleansing purposes. These are typically applied to the hands and other body parts in a liquid or damp form and adequately clean the hands. In addition, such liquid cleaners can be used to clean hard surfaces. However, use of liquid or damp cleaners is generally not appropriate with paper products, as more than extremely limited amounts of moisture can contribute to destruction of the product itself. This is particularly true for products that are physically fragile, such as paper towels and facial tissues.

Because bacteria can reside on, and be transferred by, various paper products, it would be desirable to provide a technique for limiting bacterial and microbial infection on such products. Previously described wet and damp cleansing techniques are insufficient, so it is necessary to provide techniques that differ from those used in the prior art.

### SUMMARY OF THE INVENTION

In accordance with the present invention, paper products are provided with antibiotic and antimicrobial materials at the time the paper products are made. The antimicrobial materials can be incorporated into the product either during original manufacture, or by application after the paper is formed. Incorporation of these materials into various paper products enhances the ability of these products to minimize surface contamination by unwanted bacteria.

The above as well as additional objectives, features, and advantages will become apparent in the following description.

### DETAILED DESCRIPTION OF THE PREFERRED EMBODIMENT

The present invention provides for the addition of appropriate antimicrobial materials to standard paper products. The paper products themselves are manufactured according to standard techniques, and such techniques are well known in the art. The present invention consists of including appropriate antimicrobial or antibacterial materials at appropriate stages of the paper product manufacturing process.

In a preferred process, triclosan, a well known chlorinated diphenyl ether, is used as an antimicrobial agent. After an appropriate paper product, such as a paper towel or paper eating utensil is formed, it is lightly dampened with a fluid containing triclosan, and ten allowed to dry. This leaves triclosan on the surface of the paper product, where it is able to prevent bacteria from flourishing.

The fluid is preferably another fluid known for carrying the substance, such as an alcohol based carrier. Concentrations as low as 0.001% are useful, given the high biocidal activity of triclosan. Because triclosan is a hydrophobic antibacterial agent, to allow it to be suspended long enough to come to rest on the surface of the paper product, it is useful to include a compatabilizing agent. Typical compatiblizing agents are polyhydric alcohols such as propylene glycol, ethylene glycol, polypropylene glycol, polyethylene glycol, polyoxyethylenepolyoxypropylene copolymers, glyceryl ethers and even glycerin. Amounts of the compatibilizing agent may range from 0.0001 to 50% by weight.

Advantageously the fluid medium is a water slurry that further contains from 0.0001 to 20% by weight of a binder. Suitable thickeners include organically modified cellulose and acrylic latex. Among the cellulose materials are hydroxypropyl methylcellulose, hydroxypropyl cellulose, hydroxyethyl cellulose, hydroxymethyl cellulose, methyl cellulose and carboxymethyl cellulose.

Once the fluid dries, the paper product has virtually the same physical properties as it originally had, with the addition of a surface that is resistant to bacterial growth. This provides additional usefulness in an environment in which microbial and bacterial growth is undesirable. Growth of airborne bacteria that alight on the protected surface will be inhibited.

A wide variety of paper products are suitable for use with this technique. Products with easily recognized enhanced value would include paper food service items, such as plates and cups. Paper towels and tissues having such additional protection would be accepted as having added value, and may be sold at higher prices than regular products. Clothing, sacks, packaging, liners, filters, and nearly any type of paper product are suitable for use with this concept. Personal products such as feminine products, diapers, applicator sheets and similar products are also suitable, so long as the antimicrobial agent does not interfere with the intended use of the products

The technique for applying the antimicrobial material can vary, depending on the paper product and its manufacturing process. For example, the paper in its web stage can be immersed in a solution containing the triclosan, or it can be included in the pulp from which the paper is originally manufactured. As is well known in the art, paper is wet for most of its manufacturing process, and must be dried to create the final product. Because the triclosan can be added in an aqueous suspension, this technique is suitable for use in nearly every stage of the manufacturing process.

Including the antimicrobial material in the original manufacturing process might be advantageous for products that have a relatively long life, or are subject to increased wear. Products such as paper for contracts and similar documents, and for paper currency, would be especially suitable for such use. Because the antimicrobial material impregnates the volume of the paper, rather than residing primarily on the surface, use of the paper will not wear the antimicrobial material off.

Many antimicrobial materials are suitable for use with this invention. The agent can be selected form the group consisting of halogenated salicylanilides, halogenated carbanilides, alkylbenzoylacrylates, thiuram sulfides, quaternary ammonium compounds, halogenated anilides of thiophene carboxylic acids, chlorohexidines, dithiocarbamates, halogenated bisphenols, halogenated diphenyl ethers, and antibiotics. The following list some materials that have varying levels of effectiveness when used as described:

Among the halogenated salicylanilides may be the following derivatives:

5-bromo-salicylanilide

4′,5-dibromo-salicylanilide

3,4′,5-tribromo-salicylanilide

6-chloro-salicylanilide

4′5-dichloro-salicylanilide

3,4′5-trichloro-salicylanilide

4′,5-diiodo-salicylanilide

3,4′,5-triiodo-salicylanilide

5-chloro-3′-trifluoromethyl-salicylanilide

5-chloro-2′-trifluoromethyl-salicylanilide

3,5-dibromo-3′-trifluoromethyl-salicylanilide

3-chloro-4-bromo-4′-trifluoromethyl-salicylanilide

2′,5-dichloro-3-phenyl-salicylanilide

3′,5-dichloro-4′-methyl-3-phenyl-salicylanilide

3′,5-dichloro-4′phenyl-3-phenyl-salicylanilide

3,3′,5-trichloro-6′-(p-chlorophenoxy)-salicylanilide

3′,5-dichloro-5′-(p-bromophenoxy)-salicylanilide

3,5-dichloro-6′-phenoxy-salicylanilide

3,5-dichloro-6′-(o-chlorophenoxy)-salicylanilide

5-chloro-6′-(o-chlorophenoxy)-salicylanilide

5-chloro-6′-beta-naphthyloxy-salicylanilide

5-chloro-6′-alpha-naphthyloxy-salicylanilide

3,3′,4-trichloro-5,6′-beta-naphthyloxy-salicylanilide

Halogenated carbanilides are represented by

3,4,4′-trichloro-carvanilide and the 3,3′,4-trichloro derivatives

3-trifluoromethyl-4,4′-dichlorocarbanilide.

The bis-phenols are represented by the following:

2,2′-methylenebis(4-chlorophenol)

2,2′-methylenebis(4,5-dichlorophenol)

2,2′-methylenebis(3,4,6-trichlorophenol)

2,2′-thiobis(4,6-dichlorophenol)

2,2′-diketobis(4-bromophenol)

2,2′-methylenebis(4-chloro-6-isopropylphenol)

2,2′-isopropylidenebis(6-sec-butyl-4-chlorophenol)

The useful alkylbenzoyl acrylates comprise the sodium salts of alkylbenzoylacrylic acids wherein the alkyl portion has from about 5 to about 12 carbon atoms.

Examples of quaternary ammonium compounds are:

diisobutylphenoxyethoxyethyidimethylbenzylammonium chloride

N-methyl-N-(2-hydroxyethyl)-N-(2-hydroxydodecyl)-N-benzyl ammonium chloride

Cetyl trimethylammonium bromide

Stearyl trimethylammonium bromide

Oleyl dimethylethylammonium bromide

Lauryidimethylchlorethoxyethylammonium chloride

Luryidimethylchlorethoxyethylammonium chloride

Alkyl(C.sub.8-C.sub. 18)dimethyl(3,4-dichlorobenzyl)-ammonium chloride

Lauryl pyridinium bromide

Lauryl isoquinolinium bromide

N(lauroyloxyethylaminoformylnethyl)pyridinium chloride;

Examples of the thiocarbamates and the thiuram sulfides are:

Dsodium ethylene bis-dithiocarbamate (Nabam)

Dammonium ethylene bis-dithiocarbamate(amabam)

Zn ethylene bis-dithiocarbamate (ziram)

Fe ethylene bis-dithiocarbamate (ferbam)

Mn ethylene bis-dithiocarbamate (manzate)

Tramethyl thiuram disulfide

Ttrabenzyl thiuram disulfide

Ttraethyl thiura, disulfide

Ttramethyl thiuram sulfide

From the viewpoint of safety and effectiveness the preferred antibacterial agents are as follows:

4′,5-dibromosalicylanilide

3,4;,5-tribromosalicylanilide

3,4′,5-trichlorosalicylanilide

3,4,4′-trichlorocarbanilide

3-trifluoromethyl-4,4′-dichlorocarbanalide

2,2′-methylenebis(3,4,6-trichlorophenol)

2,4,4′-trichloro-2,′-hydroxydiphenyl ether

Tyrothricin

N-methyl-N-(2-hydroxyethyl-N-(2-hydroxydodecyl)-N-benzylammonium chloride

Especially preferred are:

2,3′5-tribromosalicylanilide

Clorohexidine digluconate

Clorohexidine diaceate

4′,5-dibromosalicylanilide

3,4,4′-trichlorocarbanilide

2,4,4′-trichloro-2-hydroxydiphenyl ether

The previous discussion has focused on paper products, but the invention can also be used with similar materials having non-wood based fiber construction. The described technique can include fibers woven and nonwoven from wood, plants and/or other textile fibers including but not limited to Aramid (Nomex/Kevlar) Conductive Nylon (Polyolefin), Nylon (Bi-component side by side sheath core), Cotton, Rayon, Wool, Local and Modacrylic (Fusible co-Pet fiber) ground to its individual constituents or treated chemically, by digestion with acidic or basic liquors, to form Cellulose, the main fibrous component most suited for making paper goods. It will be apparent to those skilled in the art that impregnating a fibrous material, particularly a fibrous sheet material such as paper, will allow for the antimicrobial properties of the impregnating material to be added to the physical properties of the fibrous material.

Preferred manufacturing techniques for several different products are as follows:

Paper towels, Currency & Toilet Tissue: Preferred process is to suspend fiber material in a solution containing an antibacterial agent. This process disperses antibacterial agent through the infrastructure of individual fibers which are then processed in there traditional fashion.

Facial Tissues: A preferred process is to use a coating along with a bonding agent which are applied after the Kleenex product has been formed. Coatings of antibacterial agent may be applied in a variety of common ways.

Food Containers & Utensils: A preferred process is to impregnate infrastructure fibers with antibacterial agent. Using this method is preferred over others as it posses no safety or health risk from cross contamination onto the food product.

It will be appreciated by those skilled in the art that the improved paper product described above will provide for the manufacture of numerous paper products that are resistant to bacteria growth. Because paper based products generally are so pervasive in modern society, use of this improved paper can significantly reduce the incidence of infections of various types that are transferred via paper media. Particularly when used with personal hygiene and food service applications, the technique of incorporating antimicrobial agents into paper products has the potential to improve the medical condition of a large part of the population.

Although the invention has been described with reference to a particular embodiment, this description is not meant to be construed in a limiting sense. Various modifications of the disclosed embodiments as well as alternative embodiments of the invention will become apparent to persons skilled in the art upon reference to the description of the invention. It is therefore contemplated that the appended claims will cover any such modifications or embodiments that fall within the scope of the invention.

What is claimed is:

1. A paper product, comprising:
at least one sheet of paper material; and
an antimicrobial agent impregnating the sheet of paper, wherein bacteria are inhibited from growing on a surface of the paper.

2. The paper product of claim 1, wherein te paper product comprises a sheet of paper currency.

3. The paper product of claim 1, wherein the antimicrobial agent comprises triclosan.
